(19) United States
(12) Patent Application Publication
(10) Pub. No.: US 2025/0060061 A1
(43) Pub. Date: Feb. 20, 2025

(54) METHOD, CONNECTOR AND APPARATUS FOR CONNECTING A PIPE TO A PIT OR A WALL

(71) Applicant: Infrastructure Products Australia Pty Ltd

(72) Inventors: Daniel Prusac, Breakwater, Victoria (AU); Chanaka Madushan Abeysinghe, Heathwood, Queensland (AU); Chris Hopkins, Heathwood, Queensland (AU)

(21) Appl. No.: 18/720,270

(22) PCT Filed: Dec. 14, 2022
(86) PCT No.: PCT/AU2022/051504

§ 371 Date: Jun. 14, 2024

(30) Foreign Application Priority Data
Dec. 14, 2021 (AU) 2021904065

(51) Int. Cl. F16L 41/08; F16L 5/02

(52) U.S. Cl. CPC F16L 41/08; F16L 5/02

(57) ABSTRACT

A connector for coupling a pipe to a vessel, the connector having an inner diameter to fit over the pipe and an inlet to receive a binder to fill and seal a cavity between the connector and the pipe. The invention also relates to method for connecting a pipe to a pit or wall comprising defining an opening in a sidewall of the pit or in the wall with an insert or a frame, providing a binder within the insert or frame to seal against the pipe which is inserted into the opening or into the insert or frame, wherein the binder binds the pipe to the insert or frame. The invention also relates to a pit incorporating the connector and an assembly including the pipe fixed to the connector.

### RELATED APPLICATION

This application claims priority from Australian Patent Application Number 2021904065, the contents of which are incorporated in entirety by reference.

### TECHNICAL FIELD

The present invention relates to a method, connector and apparatus for connecting a pipe to a pit or a wall.

### BACKGROUND ART

The installation of inground piping networks frequently involves connecting pipes to a drainage pit or an access pit. Drainage pits and access pits are typically hollow concrete structures having sidewalls. In order to connect a pipe to a drainage pit, a hole is formed in the side wall of the pit during manufacture or a hole is cut in the side wall of the drainage pit and the end of the pipe is inserted into the hole. Concrete is then positioned around the pipe at the outside of the drainage pit at the junction between the pipe and the sidewall of the drainage pit to affix and seal the pipe to the pit.

FIG. 1 shows a cross-sectional view in which a pipe 14 is connected to a drainage pit using conventional techniques. In FIG. 1, the drainage pit 17 has a sidewall 10 and a bottom 11. An opening in the form of a hole or penetration 12 is formed in the sidewall 10. The pipe 14, comprising a pipe end 13 is attached to the pipe 14 via a rubber ring joint 15, then has its pipe end 13 inserted into the penetration or hole 12 in the sidewall 10 of the pit. In order to firmly hold the pipe end 13 in place, a concrete bandage 16 is placed around the outer periphery of a junction 15 between the pipe end 13 and the sidewall 10 and bottom 11 of the pit 17. Although the concrete bandage 16 shown in FIG. 1 is shown as a very tidy and quite small concrete bandage, in practice, the concrete applied round the pipe can constitute a very large amount of concrete having a very rough or untidy finish.

Current installation methods suffer from a number of disadvantages, including excessive use of concrete and other materials to seal the pipe 14 to the pit 17. Further, working in trenches create risks for labourers. Dangers include trench collapse, falling from heights, unexpected product failure could lead to crushing, and unrestrained objects falling into the trench from overhead. Working around the pipe 14, both inside and outside of the pit 17, can lead to musculoskeletal disorders from constant bending, repetition and incorrect posture.

Current installation techniques involve placing the pipe 14 into the penetration 12 and cutting the pipe 14 or pipe end 13 so that is flush with the wall 10 of the pit 17. The wall 10 is then sealed with an approved cement mixture (typically requiring minimum 32 MPa concrete). It may be necessary to render around the pipe 14 on the inside of the pit 17 to achieve a quality flush finish with the pit wall 10. Other grouting materials might be required to suit harsh soil conditions. Such grout can be specified by the site engineer, site supervisor or relevant authority. In accordance with Australian standards, the pipe should be fully supported from the supporting foundation bedding of concrete pipe (see, for example, Australian and New Zealand code AS/NZ 3725—Design for installation of buried concrete pipes).

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method, connector and apparatus for connecting a pipe to pit or a wall, which may at least partially overcome at least one of the abovementioned disadvantages or provide the consumer with a useful or commercial choice.

With the foregoing in view, the present invention in one form, resides broadly in a method for connecting a pipe to a pit or wall comprising defining an opening in a sidewall of the pit or in the wall with an insert or a frame, providing a binder within the insert or frame to seal against the pipe which is inserted into the opening or into the insert or frame, wherein the binder binds the pipe to the insert or frame.

In one embodiment, the binder also binds the pipe to the sidewall of the pit or to the wall.

In one embodiment, the step of locating a binder within the insert or frame comprises positioning one or more packets containing a binder or containing binder components in the insert or frame. In this embodiment, the step of inserting the pipe into the opening breaks the one or more packets containing the binder or binder components. The binder can then bind the pipe to the insert or frame, and hence to the sidewall of the pit or to the wall. The one or more packets may be made from a flexible plastic material or the packet may have a frangible region to allow the packet to be torn or to break when a pipe is inserted into the frame or insert.

In one embodiment, the one or more packets of binder extend into the opening defined by the insert or frame to create an internal radius smaller than the radius of the pipe. Inserting the pipe into the opening defined by the insert or frame causes the pipe to impact the one or more packets and tear the packet, thereby releasing the binder or binder components from the packets.

In one embodiment, the binder comprises a two-part binder. In this embodiment, one part of the binder reacts with the other part of the binder to set or cure the binder. In one embodiment, the first part of the binder and the second part of the binder may remain separate from each other until the pipe is inserted into the insert or frame.

In one embodiment, the step of locating the binder within the insert or frame comprises inserting one or more packets of a first binder component into the insert or frame and inserting one or more packets of a second binder component into the insert or frame. In this embodiment, inserting the pipe into the insert or frame breaks the packets and causes mixing of the first binder component and the second binder component to thereby allow the binder to set or cure.

In one embodiment, the binder comprises an epoxy binder. The epoxy binder may comprise an epoxy resin forming the first binder component and a curing agent forming the second binder component.

It will be appreciated that there are a large number of epoxy resin is commercially available that utilise a number of different curing agents. The present invention encompasses the use of any suitable epoxy binders.

The present invention also encompasses the use of any other two-part binders. In one embodiment, the binder comprises a two-part resin or a two-part chemical binder in which the separate parts can be mixed through the installation process to mix the components so that they react to harden or set and seal the joint.

In one embodiment, the insert or frame is provided with one or more nozzles and the binder is injected into the insert or frame through the nozzles. In this embodiment, the binder may be injected after the pipe has been inserted into the insert or frame. In another embodiment, the binder is injected just before the pipe is inserted into the insert frame. In this embodiment, it may not be necessary to use a 2-part binder.

In one embodiment, the insert or frame is cast or moulded into the sidewall of the pit or into the wall. For example, in order to manufacture a pit, it is typical to make the pit by slip moulding or slip casting using concrete. A mould frame or mould is constructed and concrete is poured into the mould frame or mould and allowed to set to form the pit. In one embodiment, the mould frame or mould has the insert or frame located therein and concrete is poured into the mould frame or mould and the insert or frame thereby becomes incorporated into the sidewall of the pit. The insert or frame also defines the opening in the sidewall of the pit. In embodiments where the insert or frame comprises one or more nozzles, the one or more nozzles may assist in holding the insert or frame in the desired position within the mould during casting of the pit. The one or more nozzles can also be used to inject the binder or binder components, or resins or resin components.

In one embodiment, the insert or frame comprises a plurality of components connected together to form the insert frame. For example, the insert or frame may comprise 2 parts, or 3 parts, or 4 parts, or even more parts, that connect together to form the insert or frame. In one embodiment, the insert or frame defines a circular opening in a sidewall of the pit.

In one embodiment, the insert or frame has an annular front face, an annular rear face, and a cylindrical wall connecting the front face to the rear face. In embodiments where the insert frame is made from a number of components connected together, each frame may comprise a part annular front face, a part annular rear face, and a part cylindrical wall connecting the front face to the rear face.

The insert or frame may have one or more nozzles on the front face thereof and one or more nozzles on a rear face thereof.

In one embodiment, the insert or frame includes a mesh region or a honeycomb region or a region having openings through which concrete can pass during a concrete pour. In this manner, concrete can extend into the mesh region or honeycomb region or region having openings to thereby securely attach the insert or frame to the sidewall of the pit during manufacture/casting of the pit.

In one embodiment, the mesh region or honeycomb region or region having openings extends from an outer periphery of the front face to an outer periphery of the rear face. In this embodiment, the insert or frame may also comprise a wall extending from an inner periphery of the front face to an inner periphery of the rear face. Alternatively, a cylindrical member may be positioned within the insert or frame during casting of the pit, with the cylindrical member having a radius that generally corresponds to a radius of the inner periphery of the frame or insert. In this embodiment, when concrete is poured/cast into the mould, the concrete passes through the mesh region or the honeycomb region and comes into contact with the cylindrical member. The cylindrical member then prevents concrete from flowing into the opening defined by the insert frame. In another embodiment, the cylindrical member has a radius that is larger than the radius of the inner periphery of the frame or insert. In this manner, a recess is formed in the insert or frame and that recess assists in locating the binder.

In one embodiment, one or more packets containing the binder or separate binder components are positioned within the insert or frame in the factory in which the pit is manufactured. In another embodiment, the one or more packets containing the binder or separate binder components are positioned within the insert or frame at a building site where the pipe is to be connected to the pit. In another embodiment, the pipe is inserted through the opening in the sidewall of the pit defined by the insert or frame and the binder is injected into a space between an outer wall of the pipe and the insert or frame. The binder may be injected through one or more nozzles in the insert or frame.

In a preferred embodiment of the method of the present invention, a pit is manufactured by casting the insert or frame into the sidewall of the pit. The insert or frame defines an opening in the sidewall of the pit through which a pipe that is to be connected to the pit can be inserted. One or more packets of a first binder component are placed in the inner periphery of the insert or frame and one or more packets of a second binder component are also placed in the inner periphery of the insert or frame. The one or more packets are sized and/or shaped so that they extend inwardly into the opening beyond the inner periphery of the insert or frame. A pipe is then inserted into the opening defined by the insert or frame. The pipe comes into contact with and breaks the one or more packets containing the binder components, thereby causing the binder components to mix with each other, which then sets off a curing or setting reaction. Once the binder has set or cured, the pipe is firmly connected to the sidewall of the pit.

In one implementation, the insert or frame includes annular flanges that define the opening and a cavity between the flanges into which the binder is injected to fix against the pipe when inserted in the opening.

In one implementation, the flanges are flexible to provide a seal against the pipe while the binder is injected.

In a second aspect, the present invention provides a pit comprising one or more sidewalls, at least one sidewall having an insert or frame therein, the insert or frame defining an opening in the sidewall, the insert or frame adapted to receive a binder, the opening defined by the insert or frame providing an opening into which a pipe to be connected to the sidewall can be inserted.

In one embodiment, the insert or frame includes one or more packets containing the binder. In one embodiment, the binder comprises a two-component binder and the insert or frame includes one or more packets containing a first component of the binder and one or more packets containing a second component of the binder.

In one embodiment, the insert or frame is moulded into or cast into the sidewall of the pit.

In embodiments of the second aspect of the present invention, the insert or frame may include one or more of the features of the insert or frame as described with reference to the first aspect of the present invention.

In a third aspect, the present invention provides an insert or frame for forming an opening in a sidewall of the pit, the insert or frame comprising a front face, a rear face, the front face being joined to the rear face in a manner such that concrete can be cast and extend into a region between the front face and the rear face.

In one embodiment, the insert or frame comprises a plurality of components each having a front face and a rear face with the front face being joined to the rear face in a manner such that concrete can be cast and extend into a region between the front face in the rear face, the plurality of components being joined together to form the insert or frame.

In one embodiment, the front face and/or the rear face has one or more nozzles. The nozzles may allow for injection of a binder or binder component therethrough.

In one embodiment, the insert or frame has one or more packets containing a binder or binder components located adjacent or near an inner periphery of the insert or frame.

In all aspects of the present invention, the binder may comprise a two-part binder and a plurality of packets of the first binder component are positioned within the insert or frame and a plurality of packets of the second binder component are positioned within the insert or frame. Suitably, the plurality of packets of the first binder component are interspersed with the plurality of packets of the second binder component. This will assist in mixing of the first binder component with the second binder component when the packages are broken or torn by inserting a pipe into the opening.

In another aspect, there is provided a connector for coupling a pipe to a vessel, the connector having an inner diameter to fit over the pipe and an inlet to receive a binder to fill and seal a cavity between the connector and the pipe.

In one implementation, the connector includes flanges defining an internal diameter of the connector, the cavity being defined between the flanges.

In one implementation, the flanges are formed of a resilient material to allow the pipe to pass through and seal against the pipe.

In another aspect, there is provided an assembly including a wall of a vessel and a connector as described above fixed to the wall.

In one implementation, the assembly further includes a port for injecting the binder into the cavity of the connector.

In one implementation, the port is formed in the wall and the binder is delivered through a passage to the connector.

In one implementation, the assembly further includes a pipe sealed into the wall by the connector.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a diagram showing a prior art method for connecting a pipe to a pit;

FIG. 2 shows a perspective view of an insert or frame in accordance with one embodiment of the present invention;

FIG. 3 shows a front view of the insert or frame shown in FIG. 2;

FIG. 4 shows a plan view of the insert or frame shown in FIG. 2;

FIG. 5 shows a cross sectional view of the insert or frame shown in FIG. 3, taken along section A-A as shown in FIG. 3;

FIG. 6 shows the insert or frame of FIGS. 2 to 5 mounted to a sidewall of a pit;

FIG. 7 shows a pipe being inserted into the opening defined by the insert or frame mounted to the sidewall of the pit;

FIG. 8 shows a cross sectional view of a pipe being mounted to the opening defined by the insert or frame in the sidewall of the pit shown in FIG. 6;

FIG. 9 is a front view of a pipe and vessel;

FIG. 10 is a cross-sectional view of the pipe and vessel taken along the line B-B shown in FIG. 8;

FIG. 11 is a top view of the pipe and vessel;

FIG. 12 is a partial sectional view of the pipe and vessel;

FIG. 13 is a perspective view of the pipe and vessel showing an injection point;

FIG. 14 is a perspective view of the pipe and vessel showing an alternative injection point;

FIG. 15 is a front view of a collar;

FIG. 16 is a side view of the collar; and

FIG. 17 is a perspective view of the collar.

### DESCRIPTION OF EMBODIMENTS

It will be appreciated that the drawings have been provided for the purposes of illustrating preferred embodiments of the present invention. Therefore, it will be understood that the present invention should not be considered to be limited solely to the features as shown in the attached drawings.

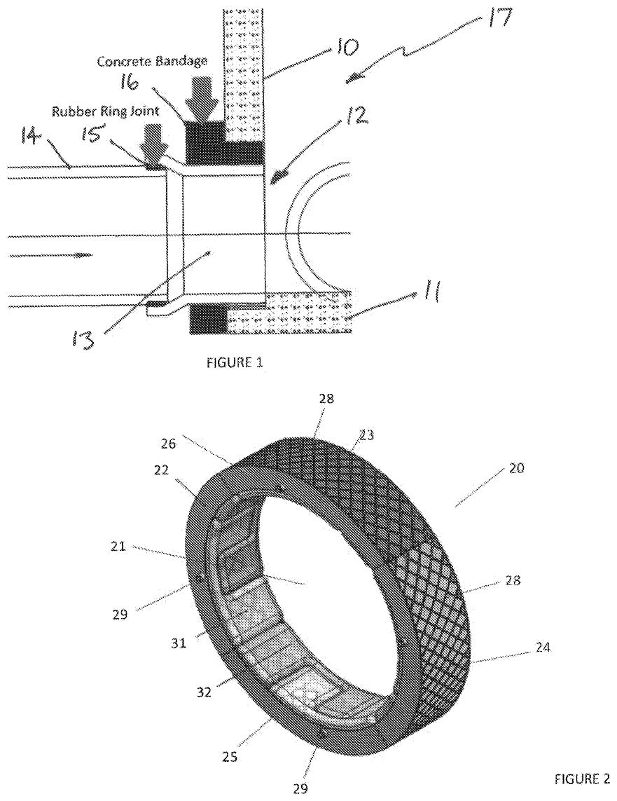

FIGS. 2 to 5 show various views of a connector in the form of an insert or frame 20 in accordance with one embodiment of the present invention. The frame 20 defines a generally circular or annular frame having a circular opening 21 therethrough. The insert or frame 20 is made of four separate frame components 22, 23, 24, 25. Each frame component effectively defines a quarter of the frame and effectively defines a quadrant of the circular opening 21.

Each frame component has a front face 26 and a rear face 27 (see FIG. 4). In use, the front face 26 is located on the outer surface of the sidewall of the pit and the rear face 27 is located on the inside surface of the sidewall of the pit. A meshed or honeycombed region 28 interconnects the front face 26 to the rear face 27. It will be appreciated that the present invention also encompasses any other way of connecting the front face to the rear face in a manner that forms openings. For example, a series of spaced parallel bars may extend from the front face to the rear face effectively around the circumference of the insert or frame 20. During manufacture of a concrete pit, concrete is cast into a slip mould, with the insert or frame 20 being mounted in the slip mould at a location required to form the opening in the sidewall of the pit. A binder, such as in the form of concrete or an epoxy resin, can pass through the meshed or honeycombed region 28 as part of the concrete pour such that concrete extends into the space between the front face 26 and the rear face 27. When the concrete sets, the insert or frame 20 is strongly connected into the sidewall of the pit.

The front face 26 is provided with a plurality of nozzles 29. The rear face 27 is provided with a plurality of nozzles 30. The nozzles 29, 30 may assist in locating the insert or frame 20 in the slip mould during casting of the pit, in order to ensure that the insert or frame 20 is properly located in the completed pit.

The insert or frame 20 also provided with a plurality of first packs 31 that contain an epoxy resin and a plurality of second packs 32 that contain a curing agent for the epoxy resin. The packs may comprise bags, such as plastic bags or tearable bags. The first and second packs together carry the 2 components needed to form a 2-part epoxy resin once the 2 components are mixed together. As can be seen from FIG. 1, the shape of the packs results in the first packs being interspersed with the second packs to ensure good mixing of the epoxy resin with the curing agent. Preferably, the shape of the packs 31, 32 also means that the packs 31, 22 interconnect with each other and lock into the frame or insert 20. The first packs and the second packs may be secured to the frame in the manufacturing process of the frame. In the embodiment shown in FIGS. 2 to 5, each frame component 22, 23, 24, 25 is provided with one pack of the epoxy resin and one pack of the curing agent. The packs 31, 32 may be positioned in the insert or frame at the factory once the pit has been removed from the slip mould. Alternatively, the packs 31, 32 may be positioned in the insert or frame 20 at a construction site.

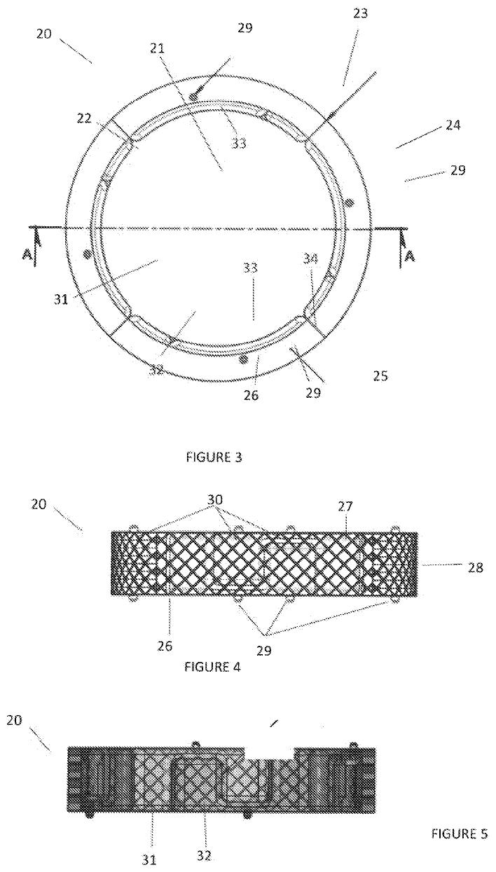

As can be seen from the FIGS. 2 and 3, the packs 30, 31 fit within the insert of frame 20 and create an internal radius that is smaller than the pipe that is to be inserted through opening 21. Hence, when the pipe is inserted into the opening 21, the impact between the packets and the pipe tears or breaks the packets, releasing the resin components and thereby allowing the curing or setting reaction to commence. As can be seen from FIG. 3, the inner surface 33 of the packs 31, 32 is located radially inwardly from the inner periphery 34 of the insert or frame 20.

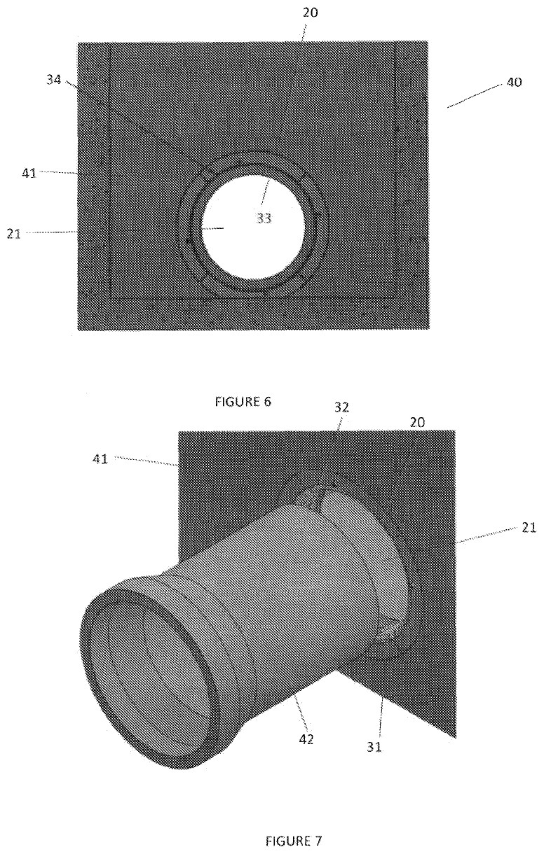

FIG. 6 shows a front view of a pit 40 incorporating the insert or frame 20 as shown in FIGS. 2 to 5. The pit 40 has a sidewall 41 and the insert or frame 20 is mounted into the sidewall 41. In order to form the pit 40, a slip mould is prepared having the required shape for the pit. The insert or frame 20 is assembled from its frame components 22, 23, 24, 25 and the insert or frame 20 is then mounted into the slip mould. A solid cylindrical insert (not shown) is located in the opening 21 of the insert or frame 20. This solid cylindrical insert may have a radius that is slightly greater than the radius of the opening 21. In that manner, the inner peripheries of the front face 26 and rear face 27 provide a radially inwardly extending lip on either side of the opening 21. Concrete is then poured into the slip mould and the concrete fills the slip mould and passes into the meshed or honeycombed region 28. However, the solid cylindrical insert prevents concrete from flowing into the opening 21. The concrete is allowed to set and the slip mould is disassembled to leave the completed pit 40 having the insert or frame 20 defining an opening 21 in the sidewall 41 of the pit. The plurality of first packs 31 and second packs 32 can then be positioned in the insert or frame prior to placing the pit in a hole. This also minimises down-hole or in-trench work required to complete the installation of the pipe.

In order to mount a pipe 42 to the sidewall 41 of the pit 40, the pipe 42 is inserted into the opening 21 (see FIG. 7). The outer radius of the pipe 42 is larger than the inner radius defined by the inner surfaces 33, 34 of the packs 31, 32. As a result, the wall of the pipe 42 impacts and tears or breaks the packs 31, 32, which causes the curing agent to mix with the epoxy resin. This, of course, sets off the curing or setting reaction for the epoxy resin. When the epoxy resin has set, the pipe 42 is firmly affixed to the sidewall 41 of the pit 40.

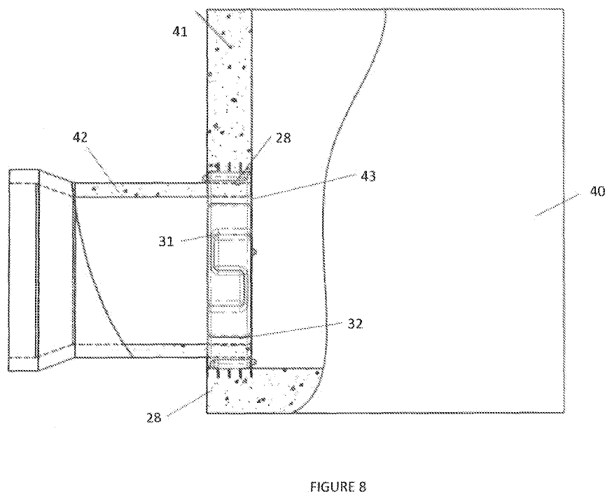

FIG. 8 shows a cross-sectional view of the pipe 42 being affixed to the sidewall 41 of the pit 40. The binder or epoxy resin is located in the region 43 between the insert 20 and the pipe 42. In some embodiments, the binder may ooze onto the outer surface of the sidewall 41 and the inner surface of the sidewall 41 in the vicinity of region 43 to thereby provide a better seal between the pipe and the sidewall of the pit.

The present invention allows for simplified installation of pipes into pits. Down-hole time or in-trench time for labourers is reduced, thereby reducing the risk of injury. Material usage is also reduced. Further, in some embodiments, the packs of binder are installed in the insert or frame 20 before the pit is installed in the hole in the ground. This also reduces down-hole or in-trench time.

In another implentation, the binder components are injected through the nozzles 30, 31 once the pipe 42 has been inserted into the opening 21. In this embodiment, feed lines for the binder components may be connected to the nozzles 30, 31 and the feed lines connected to sources of the binder components to thereby allow injection of the binder components. However, locating the binder components in the packs 31, 32 is preferred as it further reduces down-hole or in-trench time.

In an alternative embodiment (not shown in FIGS. 2 to 8) the packs 30, 31 are dispensed with and the inner periphery of the front face and rear face 26, 27 or the frame 20 is instead defined by flexible flanges to seal against the pipe and create a cavity into which the binder is injected through the frame 20 in order to seal and secure the pipe in the sidewall 41. The flexible flanges are also able to accommodate different diameter pipes, while still sealing against an outer diameter of each pipe during injection of the binder into the cavity.

FIGS. 9 to 17 show another implementation of the invention.

FIG. 9 is a front view of a pipe 50 inserted into a connector/collar 51 which is positioned in a wall 52 of a vessel 53 (previously referred to as a pit 17). The pipe 50 includes a larger diameter section 54 and a smaller diameter section 55, which is fastened in the collar 51. A port 56 allows for the injection of settable material to secure the pipe 50 in the wall 52.

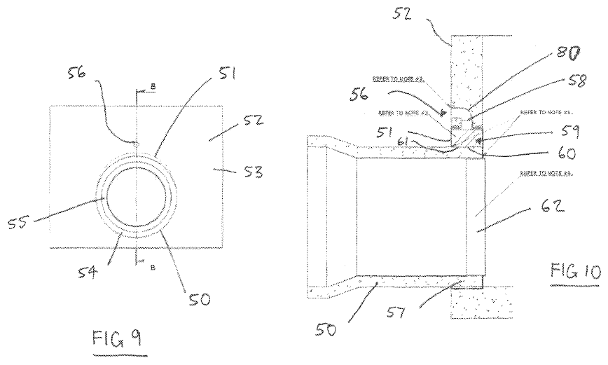

FIG. 10 shows an end 57 of the pipe 50 received in the collar 51. When the end 57 of the pipe 50 is in place in the wall 52, a settable material is injected through the port 56 to fill the collar in order to fasten the pipe 50 in position. The port 56 is connected to an elbow joint 80 which has an input 58 connected to an interior 59 of the connector/collar 51 such that when injected, the settable material firmly sets and fixes the end 57 of the pipe 50 in the wall 52.

The collar 51 is preferably cast into the wall 52 and has an internal diameter 60 to fit over the external diameter 61 of the end 57 of the pipe 50. The settable material is preferably a concrete or an expandable binder to internally fill the collar 51 and/or permeate though the internal diameter 60 to lock the pipe 50 in position, either of which assists in securing the pipe 50, even if the pipe 50 has a non-matching external diameter 61 or is not properly cut to match with the collar 51.

The end 57 of the pipe 50 is shown as having an optional inner collar 62 positioned in the pipe 50 to support sealing of the pipe 50 while the binder is activated.

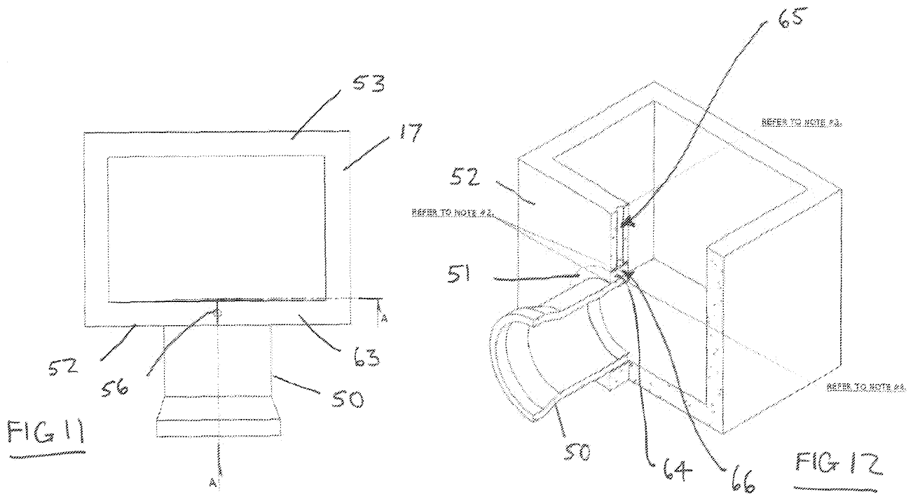

FIG. 11 is a top view of the vessel 53, in the form of a pit 17, with the pipe 50 inserted into the wall 52. In this case, the port 56 is located on a top side 63 of the wall 52.

FIG. 12 illustrates the pipe 50 secured in the wall 52 using the binder 64, which is injected through the connector 51 through a passage 65. The binder 64 is preferably an expanding resin that fills a cavity 66 between the pipe 50 and the wall 52.

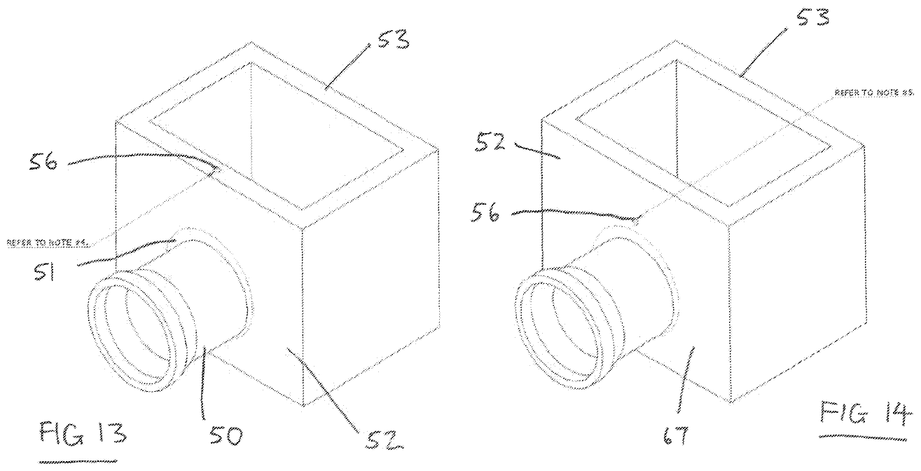

FIG. 13 is a perspective view of the vessel 53 with the pipe 50 in an installed condition. The port 56 is again illustrated at the top of the wall 52 although the port may be located in any position suitable for delivering the binder to the connector 51.

FIG. 14 is another perspective view of the vessel 53, similar to FIG. 13, except the port 56 is located in a front face 67 of the wall 52, for injection of the binder.

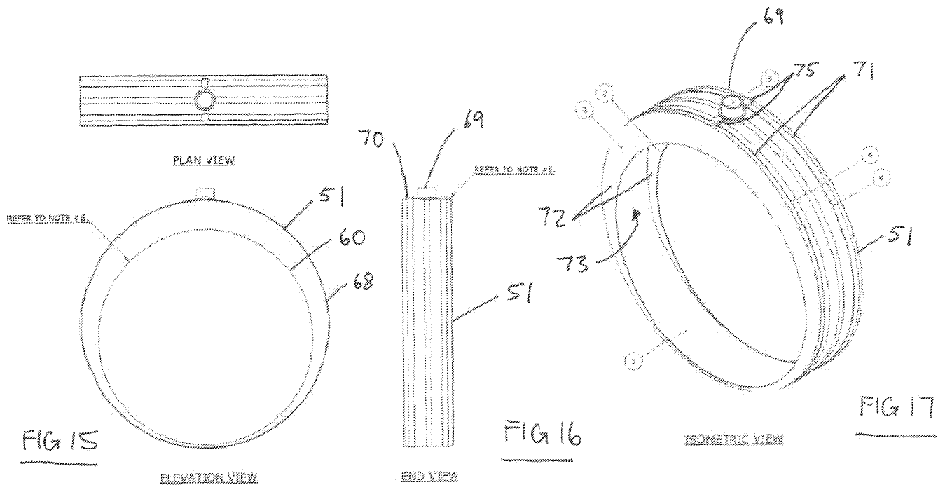

FIG. 15 shows the connector/collar 51 as being of a generally ring-shaped configuration, however, the connector 51 may be formed of multiple different shaped parts depending on pipe size and angle of the pipe 50 being installed in the wall 52. The internal diameter 60 is designed to fit over the pipe 50 shown in FIGS. 9 to 14. The connector 51 is, as mentioned above, preferably cast into the wall 52 described in the above FIGS. 9 to 14. The internal diameter 60 is preferably flexible to accommodate various diameter pipes 50 while gripping and sealing against the pipe 50. The internal diameter may also be formed of a frangible or splitable material so that insertion of the pipe 50 ruptures the internal diameter and allows settable or expandible binder to flow through the internal diameter 60 onto and around the pipe 50. In either case, the binder preferably provides a waterproof seal against the pipe 50.

The internal diameter 60 preferably forms a crescent shape inside an external body 68 of the connector 51 which facilitates enhanced flow through of the binder, when injected into the connector 51.

With regard to FIG. 16, the connector 51 has a width suitable for the application and design specifications. The connector 51 is shown with an inlet 69 at a top 70 for receiving the binder agent.

FIG. 17 illustrates the connector 51 as having peripheral ribs or ties 71 to assist in gripping and holding the connector 51 in position when cast into the wall 52 of the vessel 53. The inlet 69 has bridges 75 that connect across the ribs 71 for structural integrity.

The size of the inlet 69 is determined by the size of the pipe 50 and the flow rate needed for the binder to pass through the connector 51.

The internal diameter 60 of the connector 51 is preferably formed by flexible flanges 72 to seal against the pipe 50 to provide containment of the binder when injected through the connector 51 into a cavity 73 between the flanges 72 before setting and sealing around the pipe 50.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-56. (canceled)

57. A method for connecting a pipe into a wall of a pit comprising defining an opening in the wall with an insert or a frame, providing a binder within the insert or frame to seal against the pipe which is inserted into the opening or into the insert or frame, wherein the binder binds the pipe to the insert or frame; wherein the insert or frame includes annular flanges that define the opening and a cavity between the flanges into which the binder is injected to fix against the pipe when inserted in the opening; wherein the flanges are flexible to provide a seal against the pipe while the binder is injected, and wherein the insert or frame is cast or moulded into the wall of the pit.

58. The method of claim 57, wherein the binder also binds the pipe to the wall of the pit.

59. The method of claim 57, wherein the binder comprises an epoxy binder.

60. The method of claim 57, wherein the insert or frame is provided with one or more nozzles and the binder is injected into the insert or frame through the nozzles.

61. The method of claim 60, wherein the binder is injected after the pipe has been inserted into the insert or frame.

62. The method of claim 60, wherein the binder is injected just before the pipe is inserted into the insert or frame.

63. The method of claim 57, wherein the pit is manufactured by slip moulding or slip casting using concrete wherein the concrete is poured into a mould and allowed to set to form the pit.

64. The method of claim 63, wherein the wall of the pit has the insert or frame located therein and concrete is poured into the mould and the insert or frame thereby becomes incorporated into the wall of the pit to define an opening in the wall of the pit.

65. The method of claim 57, wherein the insert or frame comprises a plurality of components connected to form the insert frame.

66. The method of claim 57, wherein the opening is a circular opening in a sidewall of the pit.

67. The method of claim 57, wherein the insert or frame has an annular front face, an annular rear face, and a cylindrical wall connecting the front face to the rear face.

68. The method of claim 57, wherein the insert or frame includes a mesh region or a honeycomb region or a region having openings through which concrete can pass during a concrete pour.

69. The method of claim 67, wherein the insert or frame comprises a wall extending from an inner periphery of the front face to an inner periphery of the rear face.

70. The method of claim 57, wherein a cylindrical member is positioned within the insert or frame during casting of the pit, with the cylindrical member having a radius that generally corresponds to a radius of an inner periphery of the frame or insert.

71. The method of claim 70, wherein the cylindrical member has a radius that is larger than the radius of the inner periphery of the frame whereby to define the cavity for the binder.

72. The method of claim 71, wherein the binder is injected through one or more nozzles in the insert or frame.

73. The method of claim 57, wherein the insert or frame includes a peripheral rib or tie to embed in the wall and facilitate the insert or frame gripping and holding in the wall when cast or moulded into the wall of the pit.

74. A pit comprising one or more walls, at least one wall having an insert or frame therein, the insert or frame defining an opening in the wall to receive a binder, the opening being adapted to receive a pipe to be connected to the wall, wherein the insert or frame includes annular flanges that define the opening and a cavity between the flanges into which the binder is injected to fix against the pipe when inserted in the opening; wherein the flanges are flexible to provide a seal against the pipe while the binder is injected; and wherein the insert or frame is cast or moulded into the wall of the pit or into the wall.

75. The pit of claim 74, wherein the insert or frame comprises a plurality of components each having a front face and a rear face with the front face being joined to the rear face in a manner such that concrete is able to be cast and extend into a region between the front face and the rear face, the plurality of components being joined together to form the insert or frame.

76. The pit of claim 75, wherein the front face and/or the rear face has one or more nozzles to allow for injection of the binder or binder component therethrough.

77. A connector for coupling a pipe to a vessel, the connector having an inner diameter to fit over the pipe and an inlet to receive a binder to fill and seal a cavity between the connector and the pipe, including flanges defining an internal diameter of the connector, the cavity being defined between the flanges, wherein the flanges are formed of a resilient material to allow the pipe to pass through and seal against the pipe while the binder is injected into the cavity and the connector is adapted to be cast or moulded into the wall of the pit, as claimed in claim 74.

78. The connector of claim 77, further including a port to receive the binder.

79. The connector of claim 77, further including a peripheral rib or tie which embeds in the wall of the pit to secure the connector in position when the connector is cast into the wall of the pit.

80. An assembly including a wall of a vessel and a connector as claimed in claim 77 cast or moulded in the wall.

81. The assembly of claim 80, further including the inlet for injecting the binder into the cavity of the connector.

82. The assembly of claim 81, wherein the inlet is formed in the wall and the binder is delivered through a passage to the connector.

83. The assembly of claim 80, further including the pipe sealed into the wall by the connector.
